(19) United States
(12) Patent Application Publication
(10) Pub. No.: US 2011/0225458 A1
(43) Pub. Date: Sep. 15, 2011

(54) GENERATING A DEBUGGABLE DUMP FILE FOR AN OPERATING SYSTEM KERNEL AND HYPERVISOR

(75) Inventors: YUE ZUO, REDMOND, WA (US); FRANCIS MANOJ DAVID, BELLEVUE, WA (US); YIMIN DENG, SAMMAMISH, WA (US); HO-YUEN CHAU, REDMOND, WA (US); FORREST CURTIS FOLTZ, REDMOND, WA (US)

(73) Assignee: MICROSOFT CORPORATION, Redmond, WA (US)

(21) Appl. No.: 12/720,460

(22) Filed: Mar. 9, 2010

(51) Int. Cl. G06F 11/36; G06F 9/455

(52) U.S. Cl. 714/37; 718/1; 714/E11.208

(57) ABSTRACT

Cloud computing platforms having computer-readable media that perform methods to generate debuggable dump files are provided. The cloud computing platform includes server devices running operating system kernels. Optionally, the server may include a hypervisor. The operating system kernel receives a command to generate a debuggable dump file. In response, the operating system estimates memory requires to store the requested memory pages, allocates an appropriately sized buffer, and freezes computation. A hypervisor is present and if its memory pages are requested, the hypervisor freezes its computation. The hypervisor stores its memory pages in the buffer and resumes computation. The operating system kernel stores its pages to the buffer in priority order and resumes its computation. The contents of the buffer are written out as a debuggable dump file.

### BACKGROUND

Conventionally, cloud computing platforms host software applications in an Internet-accessible virtual environment. The cloud computing platform allows an organization to use datacenters designed and maintained by third parties. The conventional virtual environment supplies small or large organizations with requested hardware resources, software resources, network resources and storage resources. The virtual environment also provides application security, application reliability, application scalability, and application availability.

The software resources in a cloud computing platform may include a hypervisor that partitions physical machines into virtual machines. The operating system software running on these virtual machines provides the environment to execute software applications.

The software resources in the conventional datacenters may exhibit unexpected behaviors that require debugging. Software developers use a debugger to diagnose such behaviors. For instance, unexpected values or unauthorized access requests generated by the resource may be identified by the debugger. Accordingly, the debugger helps cure unexpected resource behaviors and reduce the number of defects in the resource. A debugger may be directly attached to the resource and allow online debugging.

For maximum effectiveness, the debugger requires a consistent view of the state of the software being debugged. There should be no computation in progress that changes data that is being inspected by the debugger. When debugging hypervisor or operating system kernel software, this consistency is achieved in two ways. All computation is halted on the machine being debugged and the debugger software is executed on a different machine connected to it. Alternatively, the hypervisor or operating system kernel software is crashed to obtain a memory snapshot. This snapshot captures a consistent view of the software state and a large number of irrelevant memory artifacts. Unfortunately, both these approaches are not viable in a cloud computing platform. It is not economically feasible to provision separate machines running debugger software. And crashing the operating system kernel software affects the availability of software applications that depend on it.

### SUMMARY

Embodiments of the invention relate, in one regard, to cloud computing platforms, computer-readable media, and computer-implemented methods that generate consistent debuggable dump files that are used by a debugger to debug resources in a cloud computing platform. The cloud computing platform consists of a number of computing devices that are available in a datacenter. The computing devices may include servers that are configured with virtualization technology. Each physical server may have a hypervisor that partitions the physical machine into a host virtual machine and guest virtual machines.

An administrator issues a command to generate a debuggable dump file. The host operating system kernel estimates the memory size required to store a complete snapshot of kernel and hypervisor memory. A memory buffer with the estimated size is allocated. The operating system kernel freezes all other computation in the system. The operating system kernel calls the hypervisor, which in turn freezes all of its computation. The hypervisor stores its memory pages and processor context to the allocated buffer, resumes its computation and returns control back to the operating system kernel. The operating system kernel stores its memory pages and processor context into the buffer. When all memory pages are saved to the buffer, the frozen computation is resumed in the operating system kernel. The memory buffer with the saved memory pages is now written to a debuggable dump file.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 is a network diagram that illustrates an exemplary cloud computing platform in accordance with embodiments of the invention;

FIG. 2 is a block diagram that illustrates an exemplary computing device configured to generate a dump file in the exemplary cloud computing platform in accordance with embodiments of the invention; and

FIG. 3 is a logic diagram that illustrates an exemplary method to generate a dump file in accordance with embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this patent, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, and firmware. Moreover, the term “hypervisor,” as utilized herein, refers to a virtualization component of the cloud computing platform.

Embodiments of the invention generate a debuggable dump file that can be loaded in a debugger. The debugger is used to diagnose issues with the resources whose state is captured in the debuggable dump file. The debuggable dump file may include any subset of memory pages in the computing device.

An administrator of the cloud computing platform issues a command to generate a debuggable dump file for the host operating system and optional hypervisor executing on a server. The command identifies the types of memory pages or a subset of memory pages that should be included in the debuggable dump file. The host operating system estimates the size of the memory buffer that will be required to store the requested memory pages. The operating system kernel allocates a memory buffer equal to the estimated size determined by the host operating system.

The host operating system kernel freezes all computation except for the process for generating the debuggable dump file. If the hypervisor is present and the administrator's command has requested memory pages for the hypervisor, the host operating system kernel calls the hypervisor. The hypervisor freezes all its computation and stores its memory pages and processor context information in the memory buffer. The hypervisor returns control to the host operating system kernel. The requested memory pages in the host operating system are prioritized based on debugging importance. The memory pages are written by the operating system kernel to the memory buffer in priority order. In an embodiment, the priority order may include first: saving memory stacks for threads; second: saving memory heaps; third: saving non-pageable data; and fourth: saving pageable data. When all requested memory pages are saved or the memory buffer is full, the operating system kernel resumes normal computation and writes the memory buffer to the debuggable dump file.

The debuggable dump file is generated from the memory buffer without crashing the cloud computing platform. The memory buffer provides a snapshot of the memory used by the operating system kernel and an optional hypervisor.

As one skilled in the art will appreciate, the cloud computing platform may include hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory technologies can store data momentarily, temporarily, or permanently.

In an embodiment, the cloud computing platform includes cloud applications that are available to client devices. The client devices access the cloud computing platform to execute the cloud applications. The cloud applications are implemented using storage and processing resources available in the cloud computing platform. The cloud computing platform may be a datacenter with several computing devices that may be virtualized to support access by the client devices.

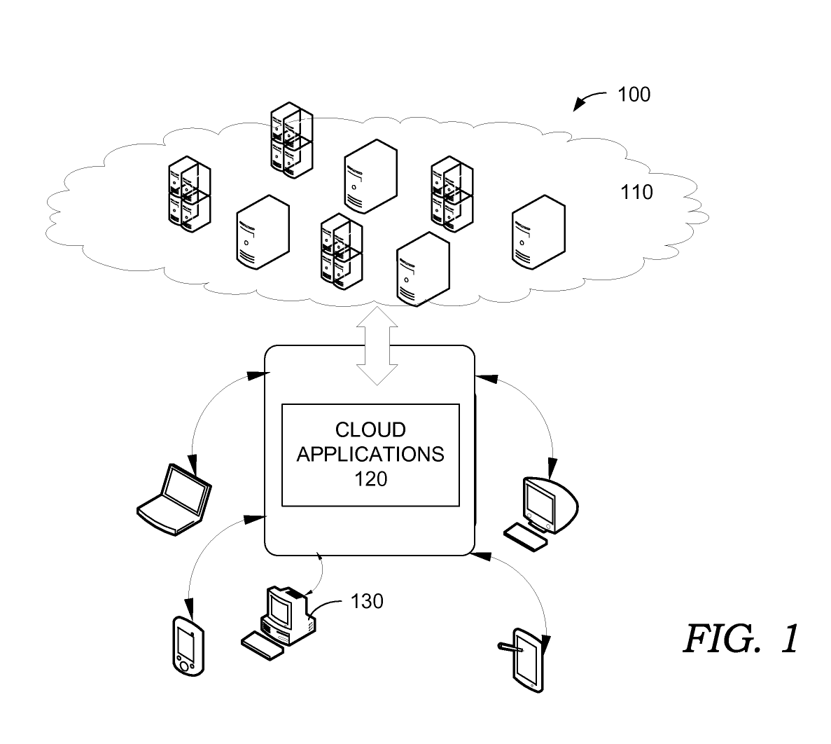

FIG. 1 is a network diagram that illustrates an exemplary cloud computing platform 100 in accordance with embodiments of the invention. The computing system 100 shown in FIG. 1 is merely exemplary and is not intended to suggest any limitation as to scope or functionality. Embodiments of the invention are operable with numerous other configurations. With reference to FIG. 1, the computing system 100 includes a cloud computing platform 110, cloud applications 120, and client devices 130.

The cloud computing platform 110 is configured to execute cloud applications 120 requested by the client devices 130. The cloud computing platform 110 connects to the client devices 130 via a communications network, such as a wireless network, local area network, wired network, or the Internet. The cloud computing platform 110 includes several computing devices that execute the cloud applications. In some embodiments, the computing devices are multiprocessor devices. Each multiprocessor device may include a host virtual machine and guest virtual machines supported by a hypervisor. The host operating system works with the hypervisor and manages all of the resources in the multiprocessor devices. Alternatively, the multiprocessor device may not use virtualization technology. Instead the multiprocessor device may simply execute a host operating system without the hypervisor.

The cloud applications 120 are available to the client devices 130. The software executed on the cloud computing platform 110 implements the cloud applications 120. In one embodiment, guest virtual machines in the cloud computing platform 110 execute the cloud applications 120. The cloud applications 120 may include editing applications, network management applications, finance applications, or any application requested or developed by the client devices 130.

The cloud computing platform 110 may be instructed to generate a debuggable dump file for a specified operating system kernel. The debuggable dump file is parsed by a debugger to allow an administrator or developer to diagnose and cure defects in software resources. The debuggable dump file provides a consistent snapshot of memory used by the operating system kernel and the optional hypervisor. The operating system kernel freezes all computation except the process that generates the debuggable dump file to prevent other processes from modifying the memory contents during generation of the debuggable dump file. This ensures that the relationship between objects stored in memory is captured correctly as they existed just prior to a request to generate the debuggable dump file.

The client devices 130 are utilized by a user to interact with cloud applications 120 provided by the cloud computing platform 110. The client devices 130, in some embodiments, register with the cloud computing platform 110 to access the cloud applications 120. Any client device 130 with an account from the cloud computing platform 110 may access the cloud applications 120 and other resources provided in the cloud computing platform 110. The client devices 130 include, without limitation, personal digital assistants, smart phones, laptops, personal computers, gaming systems, set-top boxes, or any other suitable client computing device. The client devices 130 may communicate with the cloud computing platform 110 to receive information from, or to access application processes associated with, the cloud applications 120.

Accordingly, the computing system 100 is configured with a cloud computing platform 110 that provides cloud applications 120 to the client devices 130. The cloud applications 120 remove the burden of updating and managing multiple local client applications on the client devices 130.

The cloud computing platform provides computing devices that may run a host operating system. In some embodiments, the computing device may support virtualization technology and include an optional hypervisor. The optional hypervisor works together with the host operating system kernel to implement several guest virtual machines. All the processes in the operating system kernel and the optional hypervisor are paused when generating the debuggable dump file.

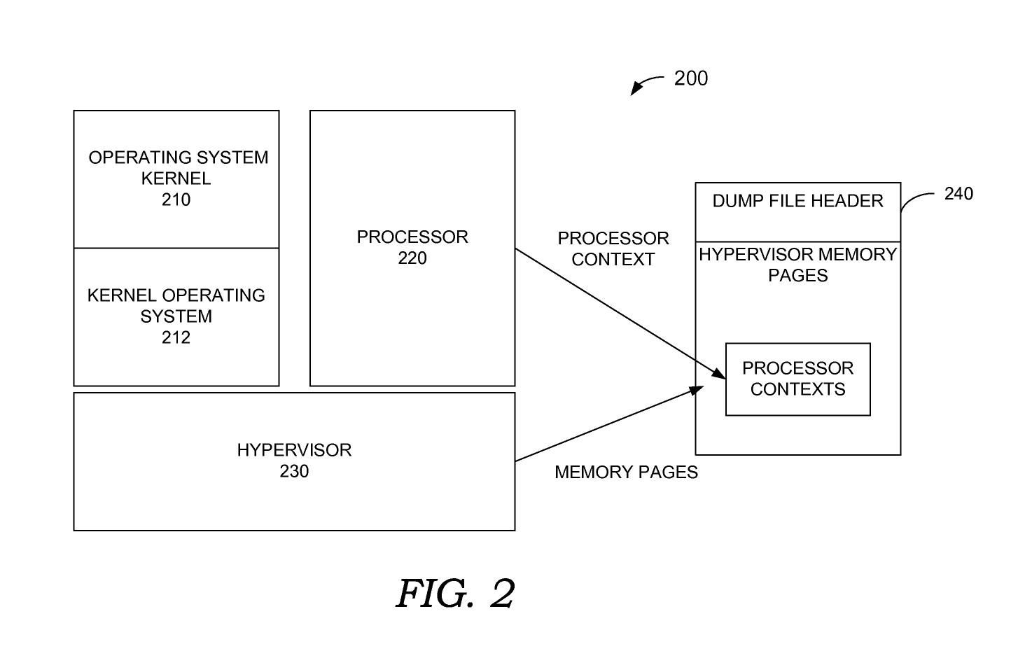

FIG. 2 is a block diagram that illustrates an exemplary computing device configured to generate a dump file 240 in the exemplary cloud computing platform in accordance with embodiments of the invention. The exemplary cloud computing device includes a host virtual machine 210, an optional hypervisor 230, and guest virtual machines 220.

The host virtual machine 210 includes an operating system kernel 212. The host operating system kernel 212 manages access to storage resources, computation resources, and rendering resources of the computing device. The host operating system kernel 212 also receives commands from the cloud computing platform. In one embodiment, the host operating system kernel 212 may receive a command to generate a debuggable dump file. In turn, the host operating system kernel 212 executes a process to generate the debuggable dump file after freezing all other computation in the host virtual machine 210 and the optional hypervisor 230.

The operating system kernel 212 provides memory management and allows the computing device to install and execute multiple applications and processes corresponding to the applications. In one embodiment, the operating system kernel 212 is a Windows™ operating system.

The optional hypervisor 230 may be used to virtualize the resources of the computing device. The hypervisor 230 provides several guest virtual machines 220 that are available to execute cloud applications. In some embodiments, each guest virtual machine 220 may also execute operating systems that differ from the host operating system kernel 212.

The computing device generates the dump file 240 in response to a command to generate the debuggable dump file. A header for the dump file may include fields that identify a version for the operating system, the type of machine, etc. The header is followed by entries that describing the pages that are saved in the debuggable dump file. The debuggable dump file stores the processor contexts and the requested memory pages. The debuggable dump file may be loaded into a debugger to diagnose and help cure the unexpected resource behavior.

In some embodiments, the cloud computing platform prioritizes the information required to debug the software resources on the computing device. The debuggable dump file may store information based on these predetermined priorities.

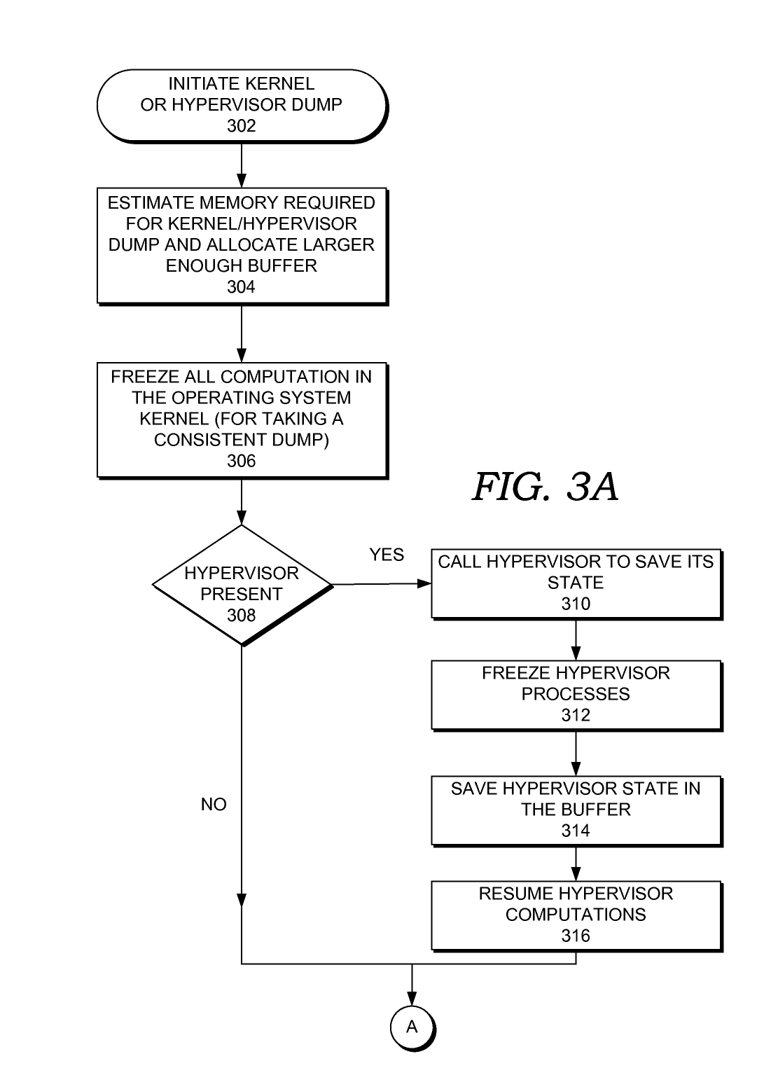

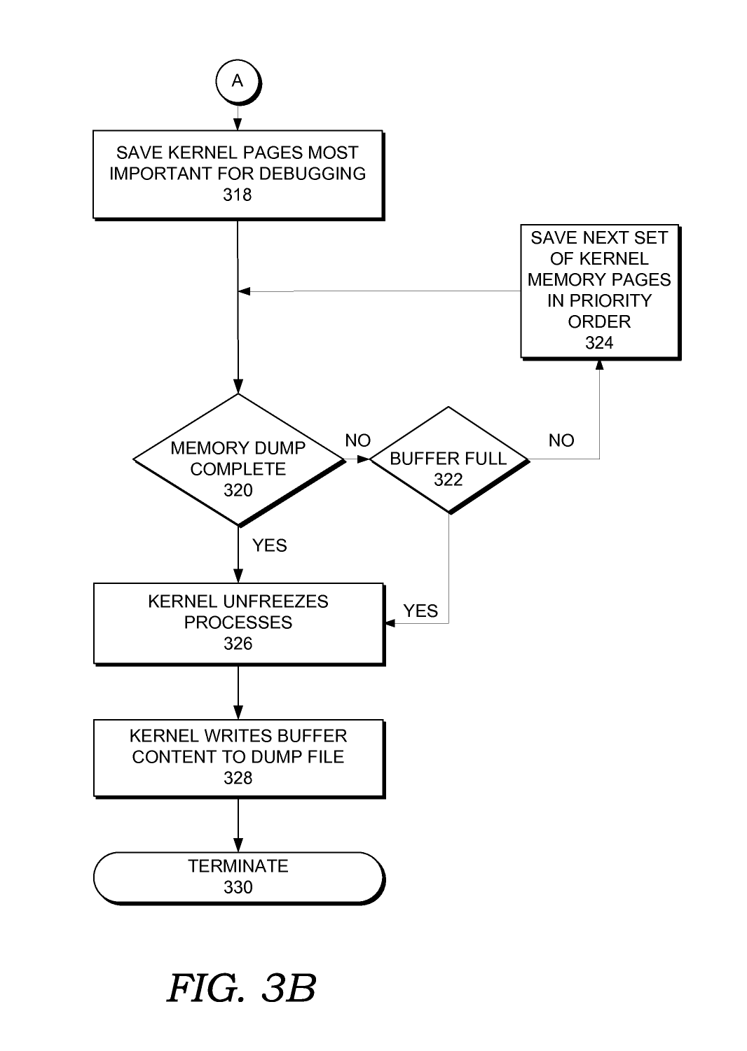

FIG. 3 is a logic diagram that illustrates an exemplary method to generate a dump file in accordance with embodiments of the invention. The method initializes, in step 302, in response to a command to generate the debuggable dump file. The host operating system kernel estimates memory needed to store the requested memory pages, in step 304. The requested memory pages may include any subset of the memory pages in the host virtual machine and the optional hypervisor. In step 306, the host operating system kernel freezes all computation. In turn, if the command requested hypervisor memory pages, the host operating system kernel checks to determine whether a hypervisor is present, in step 308.

When the optional hypervisor is present, the host operating system kernel transmits a save state command call to the hypervisor in step 310. In step 312, control is transferred to the hypervisor and it freezes computation in the hypervisor. In step 314, the hypervisor saves its state and corresponding memory pages in the buffer. The hypervisor is resumed after the state information and memory pages are stored in the buffer, in step 316.

When the optional hypervisor is not present or the state information and memory pages corresponding to the optional hypervisor is stored in the buffer, the operating system kernel saves memory pages associated with application processes executed on the host operating system kernel, in step 318. The memory pages selected first are most important for debugging the software resources. The memory pages are assigned a priority by the operating system kernel. In step 320, the host operating system kernel determines whether the memory dump from the host operating system kernel and additional processors is complete. When the memory dump is not complete, the host operating system kernel process checks the buffer to determine whether the buffer is full, in step 322. When the buffer is not full, the host operating system kernel saves additional memory pages in the buffer based on the assigned priority, in step 324.

When the memory dump is complete or the buffer is full, the host operating system kernel resumes computation, in step 326. In turn, the host operating system kernel writes the content of the buffer to the dump file, in step 328. The method terminates in step 330.

In some embodiments, when virtualization is not being used by the cloud computing platform and a hypervisor is absent, the debuggable dump file only captures memory pages and context information associated with the host operating system kernel.

The foregoing descriptions of the embodiments of the invention are illustrative, and modifications in configuration and implementation are within the scope of the current description. For instance, while the embodiments of the invention are generally described with relation to FIGS. 1-3, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

We claim:

1. A computer-implemented method to generate a debuggable dump file for an operating system kernel and hypervisor executing in a server device, the method comprising:
receiving a request to generate a dump file;
allocating a buffer to store memory pages;
freezing all other computation on the server device;
requesting the hypervisor to store its memory pages to the buffer;
storing operating system kernel memory pages in the buffer based on a priority assigned to the content;
resuming computation on the server device; and
writing the stored memory pages in the buffer to a debuggable dump file.

2. The computer-implemented method of claim 1, wherein the memory pages include any subset the following: heaps, stacks, non-paged data, and paged data.

3. The computer-implemented method of claim 1, wherein the buffer stores the memory pages that are used to debug the server or applications executed by the server.

4. The computer-implemented method of claim 1, wherein the hypervisor is optional and the debuggable dump file is generated for the operating system kernel alone.

5. The computer-implemented method of claim 1, wherein the debuggable dump file is generated for the hypervisor alone.

6. The computer-implemented method of claim 1, wherein any subset of operating system kernel or hypervisor memory pages may be requested and included in the debuggable dump file.

7. One or more computer readable media storing instructions to perform a method to create a dump file of a kernel and hypervisor in the server device, the method comprising:
receiving a request to generate a dump file;
allocating a buffer to store memory pages;
freezing all other computation on the server device; and
requesting the hypervisor to store its memory pages to the buffer;
storing operating system memory pages in the buffer based on a priority assigned to the content;
resuming computation on the server device; and
writing the stored memory pages in the buffer to a debuggable dump file.

8. The computer-readable media of claim 7, wherein the memory pages include any subset of the following: heaps, stacks, non-paged data, and paged data.

9. The computer-readable media of claim 7, wherein the buffer stores the memory pages that are used to debug the server or applications executed by the server.

10. The computer-readable media of claim 7, wherein the hypervisor is optional and the debuggable dump file is generated for the operating system kernel alone.

11. The computer-readable media of claim 10, wherein the debuggable dump file is generated for the hypervisor alone.

12. The computer-readable media of claim 7, wherein any subset of operating system kernel or hypervisor memory pages may be requested and included in the debuggable dump file.

13. A cloud computing platform configured to generate a debuggable dump file, the cloud computing platform comprising:
a server executing an operating system kernel; and
the operating system kernel configured to receive a request to generate a debuggable dump file and in response freezing its computation and saving its memory pages to a buffer.

14. The cloud computing platform of claim 13, wherein memory pages of the operating system kernel are stored in the buffer based on a predetermined priority.

15. The cloud computing platform of claim 13, wherein the operating system kernel resumes computation after saving its memory pages and writes the contents of the buffer to a debuggable dump file.

16. The cloud computing platform of claim 13, further comprising: a hypervisor, wherein the hypervisor freezes its computations in response to the request specifying memory pages for the hypervisor.

17. The cloud computing platform of claim 16, wherein the hypervisor saves the requested memory pages in the buffer and resumes computation.
